(19) United States
(12) Patent Application Publication
(10) Pub. No.: US 2013/0000685 A1
(43) Pub. Date: Jan. 3, 2013

(54) Method and apparatus for flushing of pipes

(76) Inventor: Ali Haghshenas, Houston, TX (US)

(21) Appl. No.: 13/135,257

(22) Filed: Jun. 30, 2011

(51) Int. Cl. B08B 9/032

(52) U.S. Cl. 134/166 C

(57) ABSTRACT

A flushing device for a pipeline, conduit of the like. The flushing device comprises a substantially elongate body having a proximal end adapted for connection to a source of fluid pressure, and having a distal end, and further having an aperture in a sidewall of said elongate body. The elongate body is adapted to have its distal end inserted into a pipe fitting such that said aperture is oriented in the direction of fluid flow through a pipe; such that fluid pressure introduced into said proximal end is directed into said pipe, thereby flushing said pipe.

### FIELD OF THE INVENTION

This invention relates generally to a pipe or conduit flusher device and particularly to a flusher device which expands upon the introduction of fluid pressure to seat the device in a pipeline or similar conduit, or in a fitting disposed in a pipeline or conduit. The flusher device of this invention has an improved flexible body structure with a forward end integrating an improved discharge outlet configuration to direct a concentrated fluid spray to dislodge pipeline obstructions or debris to improve fluid flow.

### BACKGROUND OF THE INVENTION

Various drain flushing devices have been proposed in the past. Typically, these prior art devices have utilized various valve structures to initially develop an internal pressure in the flushing device body to seat the device in the pipeline. Upon further introduction of fluid pressure the valve structure is opened to provide a fluid spray to dislodge the obstruction. Other devices have been proposed which utilize a resilient body structure with a restricted opening at the body forward end. Upon the introduction of fluid pressure into such devices the body is also expanded initially for seating in the pipeline, although some fluid escapes through the restricted opening. Upon further fluid introduction, the fluid escapes through the restricted opening in a concentrated spray. These latter devices use restricted openings of a circular configuration.

The prior art drain flushing devices have specific functional drawbacks in operation and, particularly, those that utilize valves are difficult and expensive to manufacture. Specifically, the valved drain flusher devices are advantageous for purposes of initial seating of the respective devices in the pipeline. Subsequently, the valves open and provide the concentrated fluid stream to dislodge the drain obstruction. The drain flusher devices that have been proposed having the restricted openings, expel considerable volumes of fluids upon initial fluid introduction, thereby, making the initial seating of the device more difficult. Subsequent the pressure build-up in the device body, fluid is expelled through the restricted opening for obstruction dislodgement, however, the configuration of the circular restricted opening limits the concentrated fluid flow that is able to be passed therethrough. Thus, in these proposed prior art devices, the initial diameter of the circular opening is limited by the proper seating requirement of the device body. Consequently, the resultant concentrated fluid flow that is able to be passed through the circular opening after the device body has been seated is, thereby, limited.

Also disclosed in the prior art (U.S. Pat. No. 5,329,646 to Bevacco et al.) is a drain flusher device which provides a structure that is purported to overcome the difficulties and limitations of other prior art devices. The drain flusher devices of the Bevacco et al. '646 patent provide the benefits of the valved drain flushers in that the device body is initially able to be fully seated in the pipeline during the seating process and before excessive expulsion of a concentrated fluid spray. The Bevacco drain flushers also provide the benefits of those proposed devices that utilize the circular restricted openings in that they are relatively inexpensive to manufacture.

The Bevacco et al. U.S. Pat. No. 5,329,646 is hereby incorporated by reference herein in its entirety.

One limitation of the Bevacco et al. '646 patent is that in order to introduce the drain flusher into a pipe or conduit to be cleared, it is necessary to sever the pipe or conduit at some point along its length, so as to place the flusher into proximity of an obstruction.

### SUMMARY OF THE INVENTION

The present invention provides a drain flusher device used in clearing obstructions from pipelines or other fluid conduits. The device is constructed and arranged to initially seat in the pipeline and then to introduce a concentrated, pressurized fluid spray through a slit or aperture to dislodge the obstruction. In accordance with one aspect of the invention, the drain flusher may be introduced into the pipe or conduit via an existing fitting.

In accordance with one aspect of the invention, a flushing device comprises an elastomeric cylindrical body of a specified diameter with a distal end wall and a proximal open neck end. A slit or aperture of a predetermined size is provided through the sidewall of the body near the distal end, as opposed to being provided in the distal end itself, as taught in the Bevacco '646 patent. The dimensions of the opening are independent of body diameter in the range described. The opening is specifically sized to be used with a fluid source, such as that obtained from a standard garden hose. The drain flusher device has a connector attached to the body neck and is adapted for attachment to a pressurized fluid source, such as a standard water hose. The slit or aperture is approximately 0.250 inches in length and has a maximum width of approximately 0.032 inches. The body diameter of the device varies from approximately 0.75 to 3.25 inches for flusher devices designed for use in pipe diameters ranging from one to six inches. The thickened wall end is approximately 250-325 percent thicker than the side wall thickness of the body. The outside lateral surface of the device body further has at least one circumferentially disposed sealing rib.

These and other benefits of this invention will become clear from the following description by reference to the drawings.

### BRIEF DESCRIPTION OF THE DRAWINGS

The various features and advantages of the present advantage are disclosed herein with reference to the drawing figures, in which:

FIG. 1 is a lateral plan view showing the drain flusher device of one embodiment of the invention;

FIG. 2 is a lateral plan view showing the drain flusher device of FIG. 1 in use in a pipeline;

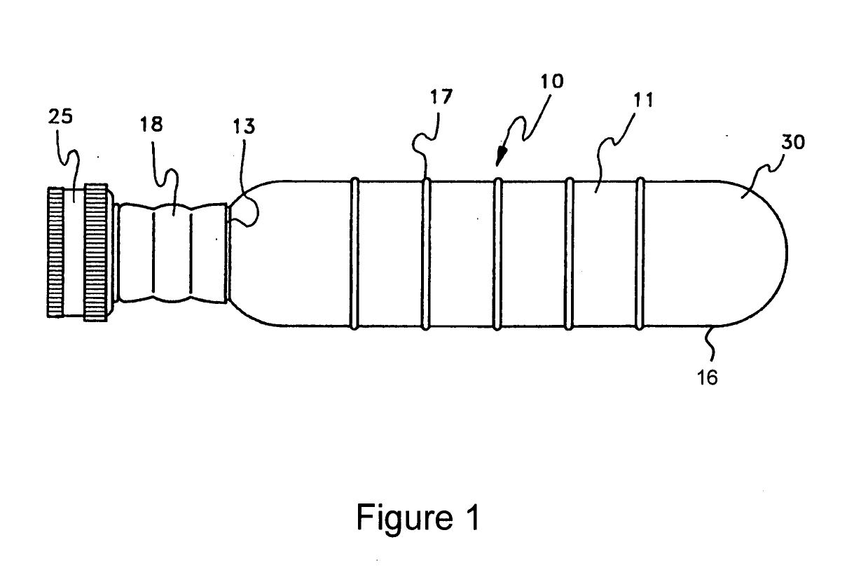

a FIG. 3 is a lateral cross-sectional view showing the body structure of the drain flusher device of FIG. 1.

### DESCRIPTION OF THE PREFERRED EMBODIMENTS

FIG. 1 shows the drain flusher device 10 having a substantially elongate elastomeric body 11 with a hemispherical distal or nose portion 30 and a connector assembly 18 attached at a neck portion 13. The connector assembly 18 is shown to have a connector head 25 for attachment to a fluid/pneumatic/hydraulic source. The connector assembly 18 is preferably a threaded connector which is adapted to receive a hose type connection. The drain flushers 10 of this invention may be used, for example, with air compressors, standard hoses (such as garden hoses) and the like, which normally provide fluid pressures of approximately 50-90 p.s.i.g. As used herein, the term “fluid pressure” shall be broadly interpreted to include, without limitation, fluid, pneumatic, and hydraulic pressure, to the extent that this term could be interpreted more restrictively. Although fluid (water) pressure is mentioned in this disclosure, the term “fluid pressure” shall be understood to encompass a broader range of applications of the invention.

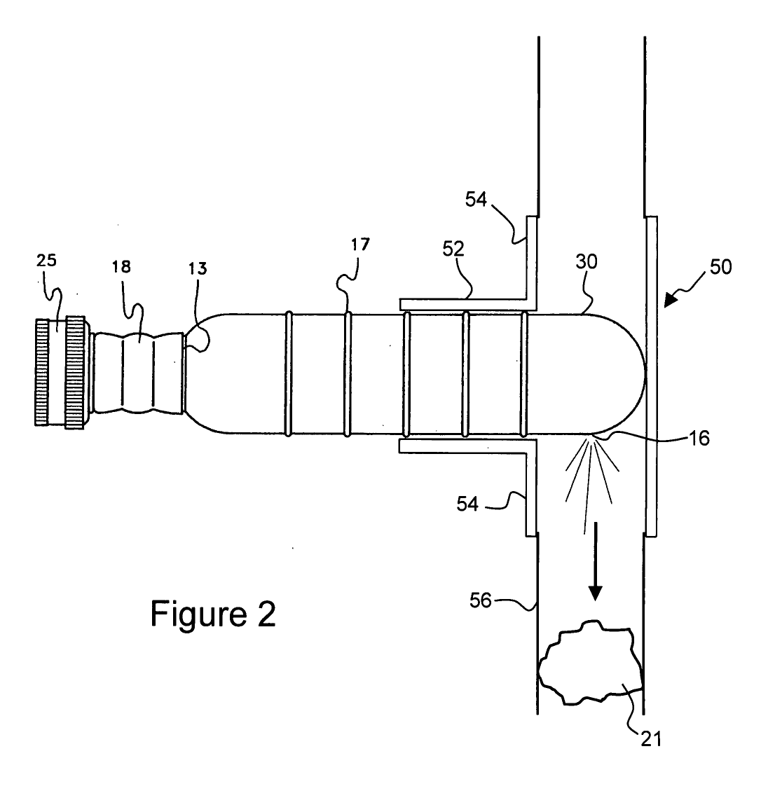

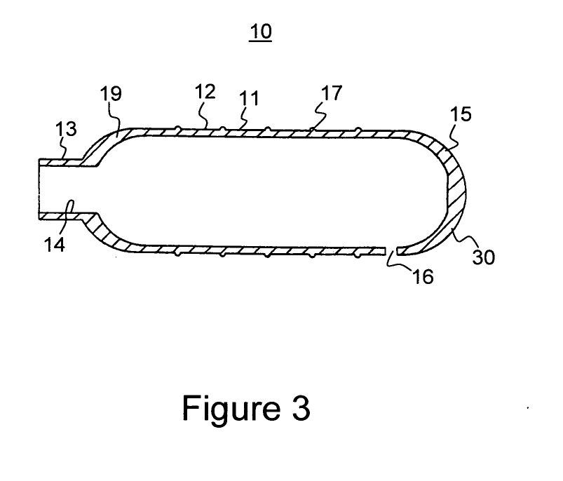

FIG. 2 shows the drain flusher 10 in an inflated state and seated in a connector 50 in the form of a “T” connector joint commonly found in piping systems. It is to be understood that the connector head 25 of the drain flusher connector 18 is adapted to be attached to the connector end of a garden hose or other source of pneumatic pressure (air or liquid). As will be further described, the elastomeric body of connector 10 is initially expanded by this source of pneumatic pressure.

It is to be understood that the substantially elongate body of flusher 10 is adapted to be inserted into any fitting that has an entry oriented substantially perpendicularly to the pipe or conduit to be flushed. A “T” fitting is an example of such a fitting, although the invention may be applied to other types of fittings.

Flusher 10 in FIG. 2 is shown having its distal end 30 inserted into the central opening 52 of connector 50. Connector 50 further comprises side openings 54 which are oriented essentially perpendicularly to central opening 52 in opposite directions, the central 52 and side 54 openings thereby defining a “T” shape to joint 50, as would be readily apparent to those of ordinary skill in the art.

Circumferentially disposed sealing ribs 17 may be provided on the exterior of the elastomeric body 11 to seal the body 11 against the inner wall of the central opening 52. Once seated within the inner wall of central opening 52, the aperture 16 in the side wall of body 11 further opens to provide a concentrated fluid spray 24 to dislodge an obstruction 21.

FIG. 3 shows a sectional view of the elastomeric flusher body 11. The elastomeric body 11 has an end wall 15 having an aperture 16. The body 11 is constructed of an elastomeric material (e.g., rubber) with a lateral wall 12 having a plurality of circumferentially disposed and spaced sealing ribs 17. The unitary body 11 is further shown to have an end wall 19 adjacent the neck portion 13. The connector assembly 18, shown in FIG. 1, is attached to the neck portion 13 in the usual manner where inner and outer sleeves are clamped about neck portion 13 to form the connector assembly 18. The end wall 19 permits the connector assembly 18 to be securely retained at the neck portion 13.

As many changes are possible to the embodiments of this invention, utilizing the teachings thereof, the description above and the accompanying drawings should be interpreted in the illustrative and not in the limited sense.

From the foregoing description and disclosure of various embodiments of the invention, it will be apparent to those of ordinary skill in the relevant arts that an apparatus for flushing pipes and the like has been disclosed. Various embodiments of the invention are described herein solely for the purposes of illustrating the invention in its various aspects. It is contemplated and to be explicitly understood that various substitutions, alterations, and/or modifications, including but not limited to any such implementation variants and options as may have been specifically noted or suggested herein, including inclusion of technological enhancements to any particular method step or system component discovered or developed subsequent to the date of this disclosure, may be made to the disclosed embodiments of the invention without necessarily departing from the technical and legal scope of the invention as defined in the following claims.

What is claimed is:

1. A flushing device comprising:
a substantially elongate body having a proximal end adapted for connection to a source of fluid pressure, and having a distal end, and further having an aperture in a sidewall of said elongate body;
wherein said elongate body is adapted to have its distal end inserted into a pipe fitting such that said aperture is oriented in the direction of fluid flow through a pipe;
such that fluid pressure introduced into said proximal end is directed into said pipe, thereby flushing said pipe.

2. A flushing device in accordance with claim 1, wherein said aperture is disposed near the distal end of said device.

3. A flushing device in accordance with claim 1, wherein said pipe fitting comprises a “T” fitting having a central opening perpendicular to at least one side opening.
